(19) United States
(12) Patent Application Publication
(10) Pub. No.: US 2026/0139805 A1
(43) Pub. Date: May 21, 2026

(54) MONO-POINT ROTATIONAL CEILING COUPLED DEVICE CONNECTOR THAT CONVEYS ELECTRICAL POWER

(71) Applicant: Exposure IP LLC, Scottsdale, AZ (US)

(72) Inventor: Daniel S. SPIRO, Scottsdale, AZ (US)

(73) Assignee: Exposure IP LLC, Scottsdale, AZ (US)

(21) Appl. No.: 19/446,468

(22) Filed: Jan. 12, 2026

Related U.S. Application Data
(63) Continuation-in-part of application No. 18/433,140, filed on Feb. 5, 2024, now Pat. No. 12,540,472.
Application No. 18/433,140 is a continuation-in-part of application No. 18/381,231, filed on Oct. 18, 2023, now Pat. No. 11,901,718.
Application No. 18/381,231 is a continuation-in-part of application No. 18/406,136, filed on Jan. 6, 2024, now Pat. No. 12,470,052.

(51) Int. Cl. F21S 8/06; F21V 5/08; F21V 21/008; F21V 21/03; F21V 21/30; F21V 23/00

(52) U.S. Cl. CPC F21S 8/061; F21V 5/08; F21V 21/008; F21V 21/03; F21V 21/30; F21V 23/001

(57) ABSTRACT

An orientation hub couples an electromechanical device, such as a luminaire with at least one bottom facing light source coupled, covered by an orientation specific lensed optics. The orientation hub enables the luminaire to rotate so as to direct light toward a targeted surface. Other devices (perhaps passive devices) coupled to the hub can be rotated to align with at least one surface or a like device by at least one of a string and a laser beam. For example, the laser beam can be projected through an array of luminaires' eye-loops that support the weight of the suspended from above luminaires.

### CROSS-REFERENCE TO RELATED APPLICATION

The present application has common inventorship with, and contains subject matter related to that disclosed in U.S. Pat. No. 11,788,692, and also claims priority to U.S. patent application Ser. No. 18/381,231 (now U.S. Pat. No. 11,901,718), U.S. patent application Ser. No. 18/406,136 (now U.S. Pat. No. 12,470,052), and U.S. patent application Ser. No. 18/433,140, the entire contents of each of which being incorporated herein by reference.

### BACKGROUND

### Technical Field

The present disclosure relates to a mechanical/electromechanical connector for a suspended ceiling device with an integral mechanism for suspended ceiling device plumbing and orientation, and more particularly to such devices that convey power. In particular, this application describes mounting a mechanical or an electromechanical device from a support structure above, enabling alignment of the mechanical or electromechanical device by horizontal rotation.

### Discussion of Background

Ceiling mounted suspended devices that are required to align with other ceiling suspended device(s) commonly require more than one point of mounting connectivity to a structure above. These mounting points of connectivity may be connected to a primary ceiling structure or to a secondary structure that couples to the primary structure. It is uncommon for all primary ceiling structure features of a building to be located directly above a plurality of mounting points for a ceiling suspended device. More commonly, an installer is required to install at least one additional secondary support structure with a device mounting point before extending a device suspension element from that mounting point. The suspended device is suspended from the at least two mounting points by at least one of a chain or an aircraft cable. The device suspended from the ceiling is typically required to be plumb, and/or oriented to align with at least one neighboring device mounted at the same height. The device suspended from the ceiling can be electrically powered as is the case with ceiling suspended lighting devices.

Power to ceiling mounted lighting devices is typically conveyed to the devices through ceiling mounted junction boxes (“J boxes”). The J boxes are typically positioned above or in proximity to the ceiling mounted devices. The ceiling mounted devices can be coupled to a J box by a rigid conduit. The J box can have a swivel joint connector that can restore at least the mounting elevation of the coupled device once it bumped by a moving object. However, the swivel connector does not restore the lighting device alignment with like neighboring device/s. Further, if the device's center of gravity is not co-aligned with the longitudinal vertical axis of the conduit, the device is subjected to undue stress.

In industrial and commercial buildings J boxes coupled to the ceiling's primary and/or secondary structures are fabricated of metal. The metal J boxes inherently have the structural capacity to support the weight of the suspended luminaires with their respective suspension elements. The ceiling suspended devices can receive their power or power and data from the J boxes coupled above or from conductors external to the J box. For example, an array of highbay lighting devices can receive power, or power and data, from a modular wiring system having a drop cord connect the powered device from the above structure.

Since the form, the size, the weight, and the center of gravity of the devices suspended from above vary, in some applications two mounting points of suspension from the ceiling may be required. Yet to save material costs and production time, installers prefer suspending ceiling suspended device/s requiring alignment by a mono-point connection.

U.S. Pat. No. 11,788,692 describes features associated with a rotational mechanical ceiling mounting device that is configured to support the load of a mechanical or electromechanical device coupled from below. The mechanical mounting device is comprised of two key elements—the first is fixed to the structure above, and the second rests on the first element and is free to rotate about the first element's central vertical axis. The mechanical or electromechanical device that is supported by the rotational mechanical mounting device couples to the second element of the mechanical mounting device that is free to rotate. The benefits of the mechanical mounting device include:
1. Ability to align a suspended device below with like neighboring device/s
2. Ability to align at least one light emitting device with orientation specific optics suspended below, with a targeted horizontal and/or vertical surface
3. Ability to convert a two-point device mounting system to a single point mounting system at the ceiling structure
4. Ability to restore device orientation when the device comes into contact with a moving object

In addition to the above benefits, the present innovation describes the ceiling mounting orientation device's capability to convey power or power and data.

### SUMMARY

The present disclosure extends the teachings of U.S. patent application Ser. No. 18/406,136 by separating the hub of the mounting orientation device from the J box that couples the hub to the mechanical or electromechanical device below. The present application shows by example the hub being physically coupled to an electromechanical device (e.g., a luminaire) rather than integrated with a J-box. In other embodiments, the coupled device can be a powered or a non-powered device. Regardless of the form of the coupled device, the hub couples to the electromechanical device at the vertical central axis of the device and/or the coupled device's central point of gravity.

Coupling the hub to a mechanical or an electromechanical device at, or in proximity to, the device's top surface enables suspending the assembly from at least one of a J box or a structural support member above. The means of suspension can be by at least one of a chain, a cable, and a conduit. Decoupling the mechanical or electromechanical device from the J box assembly shown in the prior applications has several benefits. These benefits include:

1. Ability to orient a suspended device by directly coupling the device to the support structure above, eliminating the need to first couple to a J box.

2. Ability to orient an electromechanical device at the device's set mounting level while the device is powered.

3. Conversion from two mounting connection points for orientation device orientation purpose to a single mounting point at support structure above.

4. Simplifying construction means and methods for ceiling suspended device alignment.

5. Consolidating mechanical and electrical construction processes into a single “one pass” process.

6. Material and labor cost reduction.

The present innovation applies to both mechanical and electromechanical devices. More specifically the present application describes an orientation hub that couples an electromechanical device. The electromechanical device is a luminaire with at least one bottom facing light source coupled, and covered by an orientation specific lensed optics. The orientation hub is configured to enable the luminaire to rotate so as to illuminate a targeted surface. Other un-powered devices coupled to the hub can be rotated to align with at least one surface or a like device by at least one of a string and a laser beam. For example, the laser beam can be projected through an array of luminaires' eye-loops that support the weight of the suspended from above luminaires.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIGS. 1a and 1b show enlarged top and bottom views of the rotational hub embodiments.

FIGS. 2a and 2b show enlarged top and bottom views of alternate rotational hub embodiments.

FIGS. 3a and 3b show perspective views of the rotational hubs shown in FIGS. 1a, 1b, 2a, and 2b respectively coupled to a luminaire without a refractor.

FIGS. 4a and 4b are perspective views of luminaires coupled to orientation hubs corresponding to FIG. 1a with extenders. The luminaires are directly suspended by aircraft cables from the support structure above. Power/data is conveyed to the luminaire in FIG. 4a through a J box and in FIG. 4b by modular wiring drop cord.

FIGS. 5a and 5b show perspective view of luminaires with extenders coupled to the orientation hub of FIG. 1a. The assembly is suspended by aircraft cables from a J box flange of a J box coupled to support structures above. FIG. 5a includes a power/data cord that couples to the J box and FIG. 5b includes a power/data cord for the device that couples to a modular wiring system.

FIGS. 6a and 6b show perspective views of luminaires coupled to orientation hubs corresponding to FIGS. 1a and 2a respectively. The luminaires are suspended by aircraft cables from a J box flange that is coupled to a support structure above. Power/data is conveyed to the luminaire through the J box.

FIGS. 7a and 7b show perspective view of luminaires coupled to orientation hubs corresponding to FIGS. 1a and 2a respectively. The luminaires are suspended by aircraft cables from a J box flange that is coupled to support structures above. Power/data is conveyed to the luminaire externally to the J box by means of modular wiring cables.

### DETAILED DESCRIPTION

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

The “support device” as used herein may include the previously disclosed orientation hub, extender arms, or any rigid framework capable of providing at least two distal mounting points relative to the device housing, and so in this context the “support device” is sometimes called a “support system”. The structure of this support system ensures that the tensile supports (chains or cables) are mounted distally from one another at the overhead support structure, further enhancing the lateral stability and plumbing of the device. Furthermore, the support device may be integrally coupled with the mechanical or electromechanical device as the “support system” such that one of the mounting points is fixedly secured to the mechanical or electromechanical device.

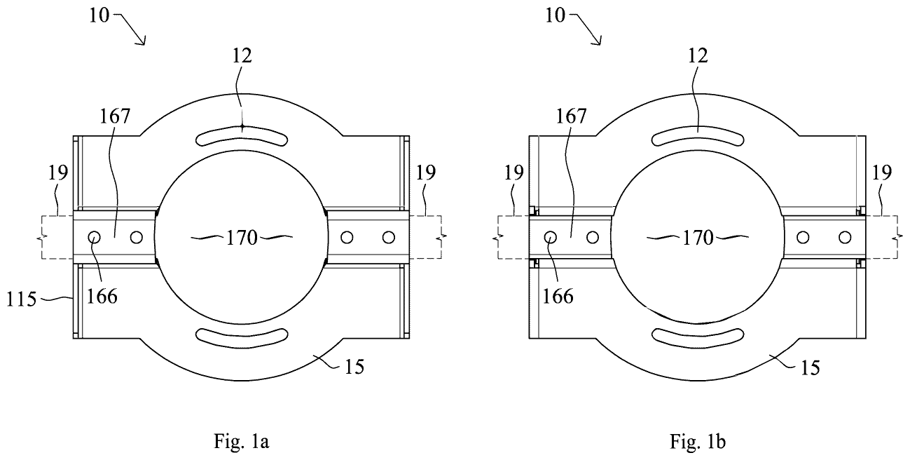

FIGS. 1a and 1b show enlarged top and bottom views of the rotational hub embodiments.

FIG. 1a shows a top view of hub 10. The hub 10 is functionally the same as the hub shown in U.S. patent application Ser. No. 18/406,136. In U.S. patent application Ser. No. 18/406,136 (see FIGS. 1a and 1b therein) the hub is shown resting on a J box flange wherein the J box is coupled to a support structure above. FIG. 1a and FIG. 1b in the present application show a portion of the hub's disk 15 trimmed to align the hub's disk 15 with the vertical walls of the luminaire device housing to which the hub couples. The elements shown include a central opening 170, an elongated bore in (or opening) 12, the hub disk 15, an extender arm base 167, a mounting bore 166, and in dashed line a portion of an extender arm 19.

The hub 10 is configured to be mechanically coupled (e.g., via fasteners) to a top surface of a mechanical or electromechanical device (not shown). The hub 10 enables the alignment of a coupled device by rotational orientation. The hub 10 can be configured to be used with both mechanical and electromechanical embodiments of different shapes and sizes.

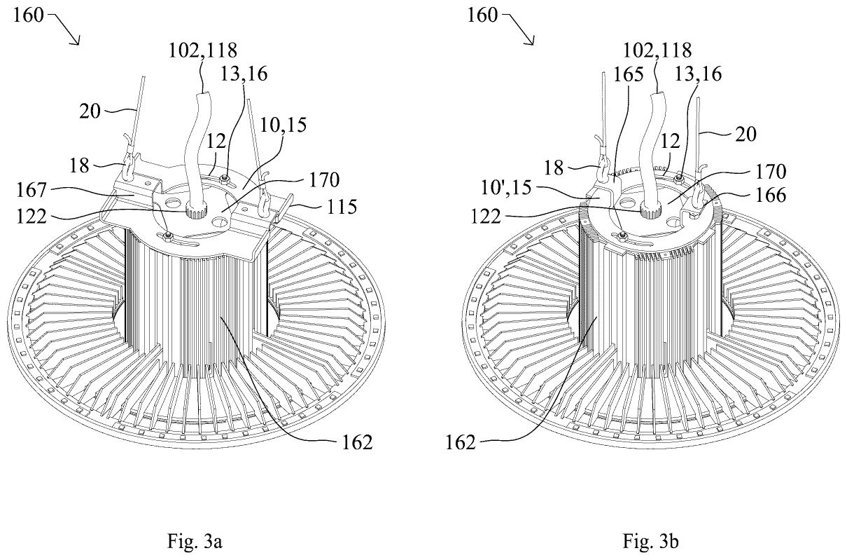

The present embodiment hub 10 is configured to couple to a luminaire (not shown) by two coupling protrusions 13 (FIG. 3b) configured to extend upwardly from the top surface of the luminaire's device housing. Each protrusion 13 can be a threaded studs that extend through the elongated bores 12 of the hub disk 15 upwardly with fasteners coupling the device to the hub disk 15. In different embodiments, bores formed in the top surface of the device can be configured to receive a threaded bolt from above through the elongated bore 12 of the hub disk 15.

Once coupled to the hub 10, the luminaire can pivot about its vertical axis using the elongated bore as guide tracks for aligning with at least one of, a like luminaire, a mechanical/electromechanical device, and a target surface to be illuminated by an orientation specific luminaire optics. The protrusions 13 coupled to the orientation hub 10 can provide at least one of a means to rotate a luminaire/device to align a luminaire with a like luminaire and/or orient luminaire optics to illuminate target surface. Orienting the luminaire can be done powered or non-powered.

The top surface of hub 10 can have marking corresponding to at least one reference marking on a surface of a coupled luminaire below or any other coupled device (not shown). The marking on hub 10 in relation to the at least one reference marking of the coupled device, can provide angular rotational displacement reading of the coupled device from base reference. Using the marking to rotationally orient the coupled luminaire/device about the central vertical axis of the hub 10 enables setting in place the device orientation prior to lifting and mounting the coupled assembly.

At opposite ends of the hub 10, hub extender arm bases 167 are configured to retain extender arms 19. The hub extender arm bases 167 are shown elevated above the surface of the hub's disk 15. The present figure shows partial extender arms 19 drawn in dashed line. The extender arms 19 are secured to the hub disk 15 by fasteners that can be placed from the top of the extender arm base 167 mounting bores 166. The extender arms 19 at the opposite ends are couple to a suspension cable or chain (not shown).

The cable or chain can couple directly to the extender arm/s 19 or couple to an intermediate fasteners like an eye loops that coupled the extender arms. The present figure also shows folds 115 in the hub disk 15 flat surface. The folds 115 provide the hub disk 15 extra structural strength to support the load imposed by the coupled device on the hub 10.

The hub central opening 170 is sized to accommodate at least one of power or power and data conductor/s connectivity to the luminaire device housing (not shown), through air flow for heat dissipation, switching devices, receptacles, and access to any other devices coupled to the top surface and or inside the luminaire device housing. The form and size of the rotational orientation hub 10 can vary to adapt to the form, size and weight of the device coupled from below.

Summarizing the coupled to a device (including a luminaire) rotational hub utility:
a. The hub two-point suspension connectivity provides a redundant safety measure to protect life and property below. When one suspension member fails, the other has the structural capacity to support the suspended assembly.
b. The hub two-point suspension connectivity maintains the orientation of the coupled device intact even when the device encounters a moving object.
c. The hub enables the rotation of the coupled device to have it aligned with a surface and/or a like device. The alignment orientation can be performed powered or unpowered.
d. The hub structure is structurally configured to securely support the entire assembly weight.
e. The hub is an inexpensive and easy to fabricate structure that can be formed anywhere across the planet.
f. The hub coupled to extender arms enables widening the distance between mounting suspension points where needed.

The present innovation utilizes a multi-point suspension architecture to achieve passive orientation restoration. Unlike mono-point systems that may allow a suspended device to spin or remain in a disturbed state after an impact, the use of at least two distal mounting points creates a mechanical “equilibrium plane.”
Center of Gravity Alignment: The support device (e.g., the orientation hub or extender arms) is configured such that the central vertical axis of the mechanical or electromechanical device's center of gravity is positioned between at least two distal mounting points.
Restorative Torque: When the suspended device makes contact with a moving object or external force, it may temporarily deviate from its set orientation. However, the distal mounting points, coupled via tensile supports (cables or chains) to an overhead structure, create a restorative gravitational torque.
Physics of Equilibrium: Because the suspension points are distally positioned from the center of gravity, any lateral or rotational displacement increases the potential energy of the system. Gravity acts as a constant force pulling the device back toward its lowest energy state-its originally set and secured orientation.

FIG. 1b shows the bottom side of hub 10 that is configured to, at least in part, to couple to the top surface of the luminaire device housing. The planar surface of hub disk 15 is substantially flat except for the inverted hub extender bases 167 that are located at opposite sides of the hub central opening 170. The inverted hub extender bases 167 show a plurality of mounting bores 166. The mounting bores 166 correspond to reciprocating bores in coupled extender/s arms 19 secured together by mechanical fastener/s. The hub 10 couples from above to a mechanical or electromechanical device and is configured to support the device weight with or without extenders.

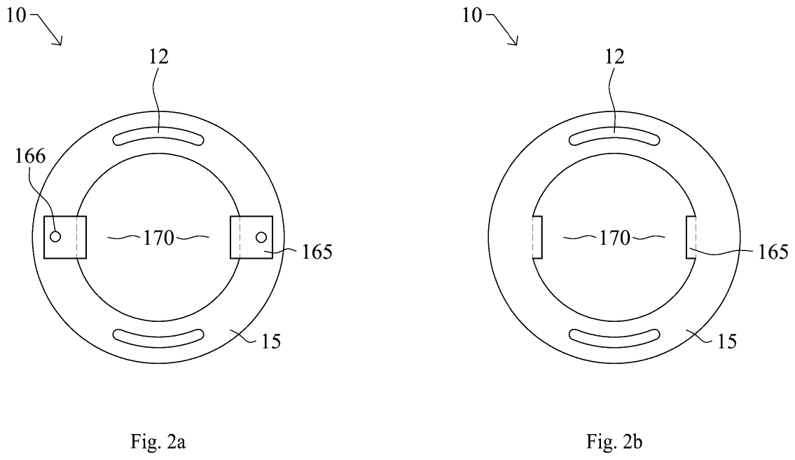

FIGS. 2a and 2b show enlarged top and bottom views of rotational alternate hub embodiments.

FIG. 2a shows an exemplary top view of an alternate hub 10′. The alternate hub 10′ is configured as a streamlined embodiment of the hub shown in FIGS. 1a and 1b. The alternate hub 10′ excludes a provision for extender arms and is configured to be directly mounted to a support structure above or to a J box above. Functionally the alternate hub 10′ is configured to perform the same device alignment task as the orientation hub 10 shown in FIGS. 1a and 1b. The alternate hub 10′ coupled to the mechanical or the electromechanical device, is configured to align the device coupled from below to at least one of, a like device, a horizontal axis, and a vertical surface.

At least one defining feature of the alternate hub 10′ is its mounting tab 165. The present figure shows the alternate hub mounting tab 165 extending upwardly from an inner perimeter of the hub central opening 170. In at least one different embodiment, the hub mounting tab 165 can extend upwardly and/or sideways from the exterior perimeter of the alternate hub 10′. The mounting hub tab 165 has at least one mounting bore 166. The mounting bore 166 is configured to couple to suspension cable/s or chains directly or indirectly by an intermediate fastener.

The alternate hub 10′ is configured to couple to a top surface of a mechanical or an electromechanical device. The alternate hub 10′ can couple mechanical and electromechanical devices of different weights, shapes, and sizes. The present application describes an alternate hub 10′ coupled to a luminaire. The present figure of the alternate hub 10′ shows two elongated through bores 12 at opposite sides of the alternate hub central opening 170. The alternate hub 10′ couples to the luminaire by protrusion 13 that extend upwardly through the elongated bores 12.

The protrusions 13 extend through the elongated bore 12 of the hub disk 15 securing the hub disk 15 to the luminaire by fasteners from above (not shown). Once coupled to the alternate hub 10′, the luminaire can pivot about its central vertical axis using the elongated bore 12 as guide tracks for alignment. The alternate hub 10′ in its various configurations facilitates alignment of luminaires that employ orientation specific optics.

Each protrusion 13 can be a threaded stud that extends through the elongated bores 12 of the hub disk 15 upwardly with fasteners coupling the device to the hub disk 15. In different embodiments, bores formed in the top surface of the device can be configured to receive a threaded bolt from above through the elongated bore 12 of the hub disk 15.

The luminaire powered or unpowered can be rotated horizontally about its vertical central axis to optimally illuminate a targeted surface. Once oriented in position, the luminaire or any other coupled device can be secured to the hub disk 15 by fasteners that couple to the through protrusions 13 in the elongated bore. The secured assembly, even if it encounters (e.g., is bumped by) a moving object, will always revert to its secured orientation position.

The electromechanical device, such as a luminaire, is configured to house light sources with specialized optics. While the orientation hub allows for the horizontal rotation of the device to target specific surfaces, the internal lensed optics may be configured for:
Symmetrical Light Distribution: Providing an even, balanced spread of light relative to the central axis of the luminaire.
Asymmetrical Light Distribution: Directing light primarily in one direction or at specific angles, such as wall-washing or pathway lighting.
Precision Alignment: Because asymmetrical optics require precise directional targeting, the ability of the hub to rotate and then permanently lock via fasteners ensures that the predetermined light intensity distribution remains directed at the intended vertical or horizontal surface.

The top surface of the alternate hub 10′ can have marking/s corresponding to at least one reference marking on a surface of a coupled luminaire below or any other coupled device (not shown). The marking on the alternate hub 10′ in relation to the at least one referenced marking of the coupled device, can provide angular rotational displacement reading of the coupled device from base reference. Using the marking to rotationally orient the coupled luminaire/device about the central vertical axis of the alternate hub 10′ enables setting in place the device orientation prior to lifting and mounting the coupled assembly.

The alternate hub central opening 170 is configured to allow at least one of, power or power and data conductor connectivity to the luminaire device housing (not shown), through air flow for heat dissipation, switching devices, receptacles, and access to any other devices coupled to the top surface and or inside the luminaire device housing. The form and size of the rotational orientation hub 10 and the rotational orientation alternate hub 10′ can vary to adapt to the form, size, and weight of the device coupled from below.

Summarizing the coupled to a device (including a luminaire) rotational alternate hub utility:
a. The hub two-point suspension connectivity provides a redundant safety measure to protect life and property below. When one suspension member fails, the other has the structural capacity to support the suspended assembly.
b. The hub two-point suspension connectivity maintains the orientation of the coupled device intact even when the device encounters a moving object.
c. The hub enables the rotation of the coupled device to have it aligned with a surface and/or a like device. The alignment orientation can be performed powered or unpowered.
d. The hub structure is structurally configured to securely support the entire assembly weight.
e. The hub is an inexpensive and easy to fabricate structure that can be formed anywhere across the planet.

FIG. 2b shows the bottom side of an alternate hub 10′ that is configured to, at least in part, couple to the top surface of a luminaire device housing. The planar surface of the hub disk 15 is substantially flat. Inside and at opposite sides of the hub central opening 170, hub mounting tabs 165 are shown extending away from the alternate hub disk 15. Elongated bores in the hub disk 15 shown at opposite sides of the hub central opening 170 are configured to receive reciprocating through protrusions 13 that extend upwardly from the top surface of the luminaire device housing or any other coupled device.

FIGS. 3a and 3b show perspective views of the rotational hubs shown in FIGS. 1 and 2 respectively coupled to a luminaire without a refractor.

FIG. 3a shows the top view of the rotational hub 10 coupled to a top portion of a luminaire 160. The assembly includes a luminaire device housing 162 coupled to the rotational hub 10 from below. Above, eye loops 18 coupled to the hub 10 with aircraft cables 20 extending to the above. The aircraft cables suspend the assembly from a support structure or a J box above (not shown). In a different embodiment aircraft cables/chains 20 can directly couple to the mounting bores of the hub 10 extender arm base 167.

At the center of the hub 10, a power or power and data drop cord 102 is shown coupled to the top surface of the luminaire device housing 162. The drop cord 102, 118 can be configured to couple by a coupler 122 to a reciprocating “plug 'n play” connector in the luminaire device housing 162. Bores shown on the top of the luminaire device housing 162 can be configured for at least one of, receive additional conductor, receive an IoT device, couple to a switching device and/or provide a venting opening to dissipate heat rising from below.

Elongated bores 12 in the hub disk are shown at opposite sides of the hub central opening. Protrusions 13 extending upwardly through the elongated bores 12 from the top surface of the luminaire device housing 162 secure the luminaire 160 to hub 10 by mechanical fasteners 16. When aligning the luminaire 160, the luminaire 160 is free to travel along the elongated bore 12 guide track to the desired alignment position. Once there, the mechanical fastener locks the assembly in its permanent orientation position.

FIG. 3b shows the top view of the rotational alternate hub 10′ coupled from above to a top portion of a luminaire 160 device housing 162. Above, eye loops 18 are shown coupled to the hub mounting tabs 165. The eye loops 18 are also shown coupled to aircraft cables 20 that extend upwardly. The aircraft cables 20 suspend the assembly from a structure above (not shown). In a different embodiment the aircraft cables/chains 20 can directly couple to the mounting bores 166 of the alternate hub 10′.

At the center of the alternate hub 10′ a power or power and data drop cord 102, 118 is shown coupled to the top surface of the luminaire device housing 162. The drop cord 102, 118 can be configured to couple by a coupler 122 to a reciprocating “plug 'n play” connector in the luminaire device housing 162. Bores shown on the top of the luminaire device housing 162 can be configured for at least one of, an additional conductor, an IoT device, a switching device, and/or a venting aperture.

Elongated bores 12 in the hub disk 15 are shown at opposite sides of the hub central opening 170. Mechanical fasteners 16 coupled to the protrusion 13 that extend upwardly through the elongated bores 12 secure the luminaire device housing 162 to the alternate hub 10′. When aligning the luminaire 160, the luminaire is free to travel along the elongated bore 12 guide track to the desired alignment position. Once there, the mechanical fastener 16 locks the assembly in its permanent orientation position.

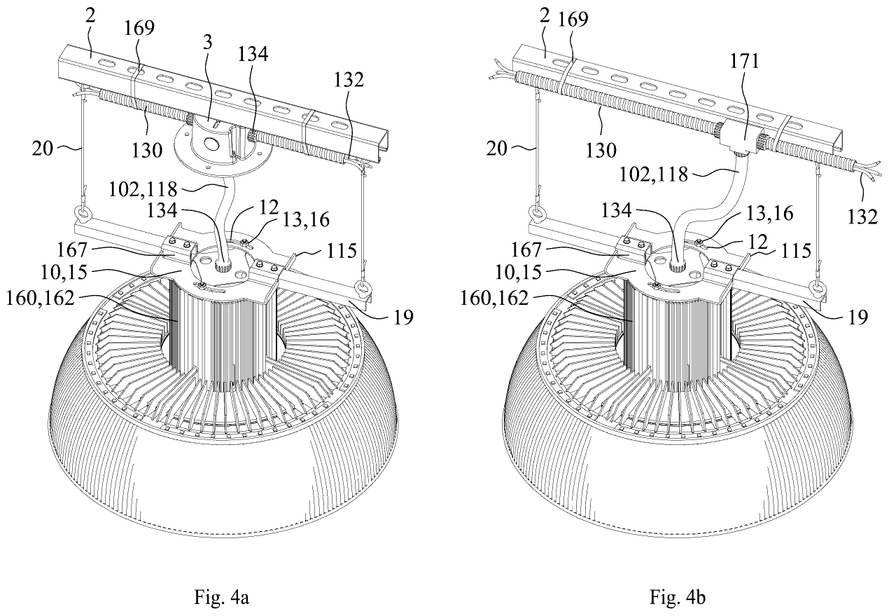

FIGS. 4a and 4b show perspective views of luminaires coupled to orientation hubs with extender arms corresponding to FIG. 1a hub.

FIG. 4a shows a luminaire 160 coupled to a hub 10 with extender arms 19 extending outwardly. The assembly including the luminaire 160 and the hub 10 are suspended from a support structure 2 above by aircraft cables 20 that couple to the extender arms 19. Power or power and data to the luminaire originate/s from inside the J box 3.

The elements shown include the rotational hub 10, 15 coupled from above to the luminaire device housing 162. Extender arms 19 coupled to the extender base 167 of the hub 10 are shown extending outwardly. Aircraft cables 20 coupled to the extender arms 19 below on the other end are coupled to the support structure 2 above. The entire assembly weight including the luminaire (device) coupled, the hub 10, the extender 19 and the suspension cables 20 with corresponding fittings of the present figure are directly supported by the support structure 2.

The coupling of the hub disk 15 to the luminaire device housing 162 gives the luminaire its rotational capability. Protrusions 13 extending through the elongated bores 12 fasten the hub disk 10, 15 to the luminaire 160, 162. Fastened by fasteners 16 from above, the hub disk 15 gives the luminaire the rotational ability for rotational orientation as well as, once aligned, fixates, and secures the assembly in place.

The present figure shows a power or power and data conductor 102,118 coupled at one end to the luminaire device housing 162 and at the other end coupled to a J box 3. Above, power or power and data extender cables 130 are shown coupled to the J box and supported by straps 169 to the support structure 169. The power/data extender cables 130 shown can include at least one conductor 132 that conveys power/data to the J box 3 and a plurality of conductors 132 inside cables and/or cords that convey power or power and data to a device mounted below and power consuming devices in the vicinity.

A power/data distribution hub (not shown) can be housed inside the J box 3. The power/data distribution hub can be an element of a factory preconfigured modular wiring system. The extender cables 130 can couple the power/data distribution hub directly by couplers 134 wherein the power distribution hub position inside the J box 3 is fixed. The power/data distribution hub can be coupled to the J box 3 cover.

The conductor 102, 118 of the luminaire can couple the power/data distribution hub through the J box cover by a coupler. The conductor 102, 118 can be supplied with the modular wiring system elements and can be field installed. The field installed conductors can couple to a reciprocating “plug n′ play” receptacle disposed on a surface of the device below. In other embodiments, power/data can be delivered to a luminaire through the J box by conventional pipe and wire assembly.

The present figure demonstrates one example of an “all in one” luminaire assembly system and a construction method wherein the mechanical, electrical and luminaire alignments can be accomplished in one step. This method requires a single “pass” where more traditional construction practices require at least two passes.

FIG. 4b shows a luminaire 160 coupled to a hub 10 with extender arms extending outwardly. The assembly including the luminaire 160 and the hub 10 are suspended directly from a support structure 2 above by aircraft cables 20 that couple to the extender arms 19. Power or power and data to the luminaire 160 is/are conveyed by means of modular wiring system from above.

The elements shown include a rotational hub 10, 15 coupled from above to the luminaire device housing 162. Extender arms 19 coupled to the extender base 167 of the hub 10 are shown extending outwardly. Aircraft cables 20 coupled to the extender arms 19 below on the other end are coupled to the support structure 2 above. The entire assembly weight including the luminaire (device) coupled, the hub 10, the extender 19 and the suspension cables 20 with corresponding fittings of the present figure are directly supported by the structure 2.

The coupling of the hub disk 15 to the luminaire device housing 162 gives the luminaire its rotational capability. Protrusions 13 extending through the elongated bores 12 of the hub disk 10, 15 fasten the luminaire 160, 162 to the hub 10. Fastened by fasteners 16 from above, the hub disk 15 gives the luminaire the rotational ability for rotational orientation as well as, once aligned, fixates, and secures the assembly in place.

The present figure shows a power or power and data conductor 102, 118 coupled at one end to the luminaire device housing 162 and at the other end to a modular wiring system splitter 171. The power or power and data cables 130 are shown coupled to the support structure 2 by straps 169. The power/data extender cables 130 shown can include at least one conductor 132 that conveys power/data through the splitter 171 to power consuming devices beyond. Through the splitter 171 the power/data can be conveyed to conductor/s 102, 118 that conveys power/data to a device coupled by a coupler 134 to the luminaire 160 below and at least one additional power/data consuming device in the vicinity. In other embodiments where modular wiring systems are not used, power/data can be delivered to a luminaire by a conventional pipe and wire assembly that can include a J box.

The present figure demonstrates one example of an “all in one” luminaire assembly system and a construction method wherein the mechanical, electrical and luminaire alignments can be accomplished in one step. This method requires a single “pass” where more traditional construction practices require at least two passes.

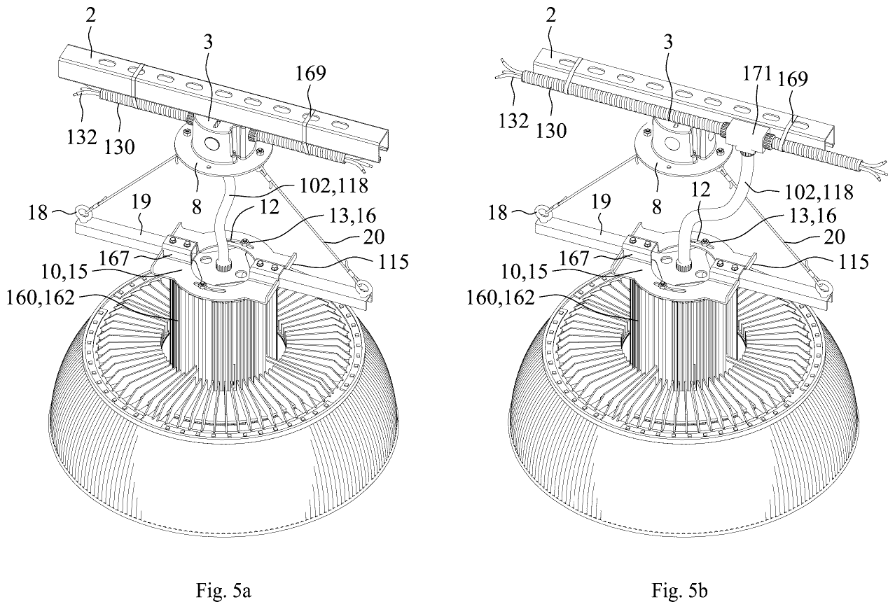

FIGS. 5a and 5b show perspective views of luminaires coupled to orientation hubs with extender arms corresponding to FIG. 1a. Both figures show the device assemblies mechanically supported by a J box.

FIG. 5a shows a luminaire 160 coupled to a hub 10 with extender arms 19 extending outwardly. The assembly including the luminaire 160 and the hub 10 is suspended from a support structure 2 above by aircraft cables 20 that couple to the extenders 19. Power or power and data to the luminaire 160 originate/s from inside the J box 3.

The elements shown include the rotational hub 10, 15 coupled from above to the luminaire device housing 162. Extender arms 19 coupled to the extender base 167 of the hub 10 are shown extending outwardly. Aircraft cables 20 coupled to the extender arms 19 at one end are coupled to a J box flange 8 of J box 3 above at the other end. The J box 3 couples to the support structure 2 and it is fixed in position.

The aircraft cables 20 of the present embodiment are shown coupled to eye loops 18 that in turn couple to the extenders 19. In other embodiments, the suspension device can couple directly to the extenders' mounting bores on the hub's extender base 167. The entire assembly weight including the luminaire (device) coupled, the hub 10, the extenders 19, and the suspension cables 20 with corresponding fittings are supported by the J box flange 8.

The coupling of the hub disk 15 to the luminaire device housing 162 gives the luminaire its rotational capability. Protrusions 13 extending through the elongated bores 12 fasten the hub disk 10, 15 to the luminaire 160, 162. Fastened by fasteners 16 from above, the hub disk 15 gives the luminaire the rotational ability for device orientation as well as, once aligned, fixates, and secures the assembly in place.

The present figure shows a power or power and data conductor 102, 118 coupled at one end to the luminaire device housing 162 and coupled at the other end to the J box 3. Above, power or power and data cables 130 are shown coupled to the J box and supported by straps 169 to the support structure 2. The power/data extender cables 130 shown can include at least one conductor 132 that conveys power/data to the J box 3 and a plurality of conductors 132 inside cables and/or cords that convey power or power and data to a device mounted below and power consuming devices in the vicinity.

A power/data distribution hub (not shown) can be housed inside the J box 3. The power/data distribution hub can be an element of a factory preconfigured modular wiring system. The extender cables 130 can couple the power/data distribution hub directly by couplers wherein the power distribution hub position inside the J box 3 is fixed. The power/data distribution hub can be coupled to the J box 3 cover.

The conductor 102, 118 of the luminaire can couple the power/data distribution hub by a coupler and/or can be supplied with the balance of the modular wiring system elements and in the field couple to a reciprocating “plug n′ play” receptacle disposed on a surface of the luminaire/device below. In other embodiments, power/data can be delivered to a luminaire through the J box by conventional pipe and wire assembly.

The present figure demonstrates one example of an “all in one” luminaire assembly system and a construction method wherein the mechanical, electrical and luminaire alignments can be accomplished in one step. This method requires a single “pass” where more traditional construction practices require at least two passes.

FIG. 5b shows a luminaire 160 coupled to a hub 10 with extender arms 19 extending outwardly. The assembly including the luminaire 160 and the hub 10 is suspended from a J box 3 above by aircraft cables 20 that couple to the extender arms 19. Power or power and data to the luminaire is/are conveyed externally to the J box 3 by means of modular wiring from above.

The elements shown include a rotational hub 10, 15 coupled from above to the luminaire device housing 162. Extender arms 19 coupled to the extender base 167 of the hub 10 are shown extending outwardly. Aircraft cables 20 coupled to the extender arms 19 at one end are coupled to a J box flange 8 of J box 3 above at the other end. The J box 3 couples to the support structure 2 and it is fixed in position.

The aircraft cables 20 of the present embodiment are shown coupled to eye loops 18 that in turn couple to the extenders 19. In other embodiments, the suspension device can couple directly to the extenders' mounting bores of the hub's extender base 167. The entire assembly weight including the luminaire (device) coupled, the hub 10, the extenders 19, and the suspension cables 20 with corresponding fittings are supported by the J box flange 8.

The coupling of the hub disk 15 to the luminaire device housing 162 gives the luminaire its rotational capability. Protrusions 13 extending through the elongated bores 12 of the hub disk 15 fasten the hub disk 15 to the luminaire 160, 162 by fasteners 16 from above. The hub disk 15 gives the luminaire the rotational ability for orientation as well as, once aligned, fixates, and secures the assembly in place.

The present figure shows a power or power and data conductor 102, 118 coupled at one end to the luminaire device housing 162 and at the other end to a modular wiring system splitter. The power or power and data cables 130 are shown coupled to the support structure 2 by straps 169. The power/data extender cables 130 shown can include at least one conductor 132 that conveys power/data through the splitter 171 to power consuming devices beyond.

Through the splitter 171 the power/data can be conveyed to conductors 102, 118 that conveys power/data to a device coupled below and at least one additional power/data consuming device in the vicinity. In other embodiments where modular wiring systems are not used, power/data can be delivered to a luminaire by conventional pipe and wire assembly that can include a J box.

The present figure demonstrates one example of an “all in one” luminaire assembly system and a construction method wherein the mechanical, electrical and luminaire alignments can be accomplished in one step. This method requires a single “pass” where more traditional construction practices require at least two passes.

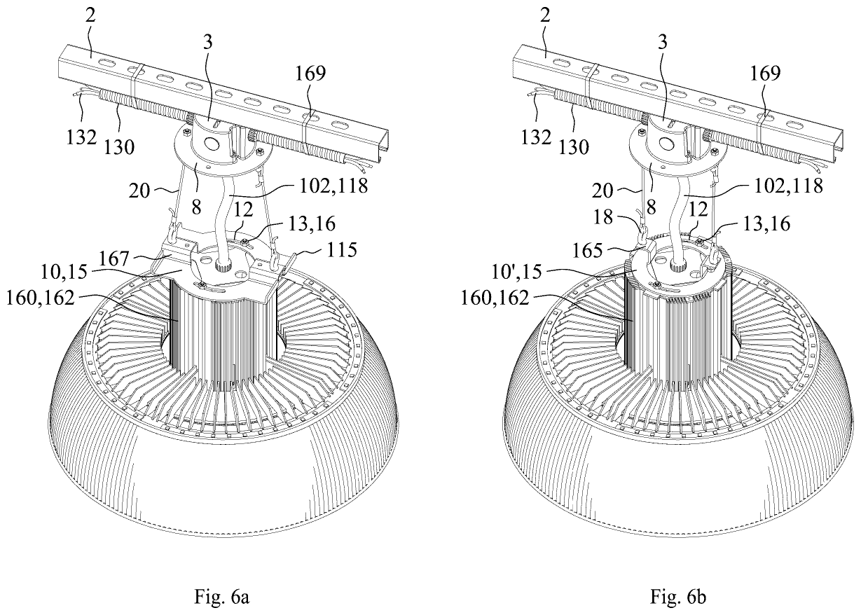

FIGS. 6a and 6b show perspective views of luminaires coupled to orientation hubs corresponding to FIGS. 1a and 2a respectively. The luminaires are suspended by aircraft cables from a J box flange that is coupled to a support structure above.

FIG. 6a shows a luminaire coupled to a rotational hub 10. The hub 10 shown is suspended from above by aircraft cables 20. The cables 20 at one end are coupled to the hub 10 and on the other end are coupled to a flange 8 of a J box 3 above. The J box 3 is fixated to the above support structure 2. Power or power and data to the luminaire 160 originate/s from inside the J box 3.

The elements shown include the rotational hub 10, 15 coupled from above to the luminaire device housing 162. The aircraft cables 20 of the present embodiment are shown coupled to I-loops 18. The entire assembly weight including the luminaire (device) coupled, the hub 10, the extenders 19, and the suspension cables 20 with corresponding fittings are supported by the J box flange 8.

The coupling of the hub disk 15 to the luminaire device housing 162 gives the luminaire its rotational capability. Protrusions 13 extending through the elongated bores 12 of the hub disk 15 fasten by fasteners 16 the hub 10, 15 and the luminaire 160, 162 assembly from above. The hub disk 15 provides the luminaire (device) its rotational ability for horizontal rotational orientation, and can also, once aligned, fixate and secure the assembly in place.

The present figure shows a power or power and data conductor 118 coupled at one end to the luminaire device housing 162 and coupled at the other end to the J box 3. Above, power or power and data extender cables 130 are shown coupled to the J box 3 and supported by straps 169 to the support structure 2. The power/data extender cables 130 shown can include at least one conductor 132 that conveys power/data to the J box 3 and a plurality of conductors 132 inside cables and/or cords that convey power or power and data to a device mounted below and power consuming devices in the vicinity.

A power/data distribution hub (not shown) can be housed inside the J box 3. The power/data distribution hub can be a standard factory preconfigured modular wiring system component. The extender cables 130 can couple the power/data distribution hub directly by couplers wherein the power distribution hub position inside the J box 3 is fixed. The power/data distribution hub can be coupled to the J box 3 cover.

The conductor 118 of the luminaire can couple the power/data distribution hub by a coupler and/or can be supplied with the balance of the modular wiring system components. This component can be field coupled to a reciprocating “plug n′ play” receptacle disposed on a surface of the device below. In other embodiments, power/data can be delivered to a luminaire through the J box by conventional pipe and wire assembly.

The present figure demonstrates one example of an “all in one” luminaire assembly construction method wherein the mechanical, electrical and luminaire alignments can be accomplished in one step. This method is contrary to more traditional construction practices that require at least two passes.

FIG. 6b shows a luminaire coupled to a rotational alternate hub 10′. The alternate hub 10′ shown is suspended by aircraft cables 20. The cables 20 at one end are coupled to the hub 10 and on the other end are coupled to a flange 8 of a J box 3 above. The J box 3 is fixated to the above support structure 2. Power or power and data to the luminaire 160 originate/s from inside the J box 3.

The elements shown include the rotational alternate hub 10, 15 coupled from above to the luminaire device housing 162. The aircraft cables 20 of the present embodiment are shown coupled to eye loops 18 that in turn couple to the hub mounting tables 165 of the alternate hub 10′. In other embodiments, the suspension device can couple directly to mounting bores 166 of the hub mounting tabs 165. The entire assembly weight including the luminaire (device) coupled, the hub 10, and the suspension cables 20 with corresponding fittings are supported by the J box flange 8.

The coupling of the hub disk 15 to the luminaire device housing 162 gives the luminaire its rotational capability. Protrusions 13 extending through the elongated bores 12 of the hub disk 15 fasten by fasteners 16 the hub 10, 15 and the luminaire 160, 162 assembly from above. The hub disk 15 provides the luminaire (device) its rotational ability for horizontal rotational orientation, and can also, once aligned, fixate and secure=the assembly in place.

The present figure shows a power or power and data conductor 118 coupled at one end to the luminaire device housing 162 and at the other end to a modular wiring system splitter. The power or power and data cables 130 are shown coupled to the support structure 2 by straps 169. The power/data extender cables 130 shown can include at least one conductor 132 that conveys power/data through the splitter to power consuming devices beyond.

Through the splitter the power/data can be conveyed to conductors 118 that conveys power/data to a device coupled below and at least one additional power/data consuming device in the vicinity. In other embodiments where modular wiring system is not used, power/data can be delivered to a luminaire by conventional pipe and wire assembly that can include a J box.

The present figure demonstrates one example of an “all in one” luminaire assembly construction method wherein the mechanical, electrical and luminaire alignments can be accomplished in one step. This method is contrary to more traditional construction practices that require at least two passes.

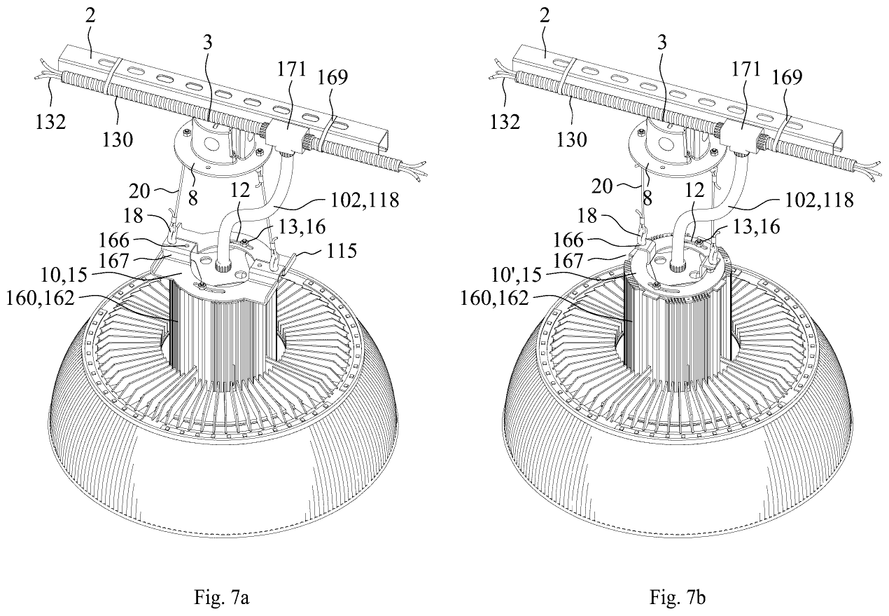

FIGS. 7a and 7b show perspective views of luminaires coupled to orientation hubs corresponding to FIGS. 1a and 2a respectively. The luminaires are suspended by aircraft cables from a J box flange that is coupled to support structures above. Power/data is conveyed to the luminaire externally to the J box by means of modular wiring cables.

FIG. 7a shows a luminaire coupled to a rotational hub 10. The hub 10 shown is suspended by aircraft cables 20.

The aircraft cables 20 at one end are coupled to the hub 10 and on the other end are coupled to a flange 8 of a J box 3 above. The J box 3 is fixated to the above support structure 2. Power or power and data to the luminaire 160 originate/s externally to the J box 3.

The elements shown include the rotational hub 10, 15 coupled from above to the luminaire device housing 162. The aircraft cables 20 of the present embodiment are shown coupled to I-loops 18 that in turn couple to the extender base 167 of the hub 10. In other embodiments, the suspension devices can couple directly to mounting bores 166 of the extension base 167. The entire assembly weight including the luminaire (device) coupled, the hub 10, and the suspension cables 20 with corresponding fittings are supported by the J box flange 8.

The coupling of the hub disk 15 to the luminaire device housing 162 gives the luminaire its rotational capability. Protrusions 13 extending through the elongated bores 12 of the hub disk 15 fasten by fasteners 16 the hub 10, 15 and the luminaire 160, 162 assembly from above. The hub disk 15 provides the luminaire (device) its rotational ability for horizontal rotational orientation, and can also, once aligned, fix and secure the assembly in place.

The present figure shows a power or power and data conductor 118 coupled at one end to the luminaire device housing 162 and at the other end to a modular wiring system splitter 171. The power or power and data cables 130 are shown coupled to the support structure 2 by straps 169. The power/data extender cables 130 shown can include at least one conductor 132 that conveys power/data through the splitter to power consuming devices beyond.

Through the splitter 171 the power/data can be conveyed to conductors 118 that conveys power/data to a device coupled below and at least one additional power/data consuming device in the vicinity. In other embodiments where modular wiring systems are not used, power/data can be delivered to a luminaire by conventional pipe and wire assembly that can include a J box.

The present figure demonstrates one example of an “all in one” luminaire assembly construction method wherein the mechanical, electrical and luminaire alignments can be accomplished in one step. This method is contrary to more traditional construction practices that require at least two passes.

FIG. 7b shows a luminaire 160 coupled to a rotational alternate hub 10′. The alternate hub 10′ shown is suspended by aircraft cables 20. The aircraft cables 20 at one end are coupled to the rotational alternate hub 10′ and on the other end are coupled to a flange 8 of a J box 3 above. The J box 3 is fixated to the above support structure 2. Power or power and data is conveyed to the luminaire 160 externally to the J box 3.

The elements shown include the rotational alternate hub 10′, 15 coupled from above to the luminaire device housing 162. The aircraft cables 20 are shown coupled to I-loops 18 that in turn couple to the hub mounting tables 165 of the alternate hub 10′. In other embodiments, the suspension device can couple directly to mounting bore 166 of the hub mounting tab 165. The entire assembly weight including the luminaire (device) coupled, the hub 10, and the suspension cables 20 with corresponding fittings are supported by the J box flange 8.

The coupling of the hub disk 15 to the luminaire device housing 162 gives the luminaire its rotational capability. Protrusions 13 extending through the elongated bores 12 of the hub disk 15 fasten by fasteners 16 the hub 10, 15 and the luminaire 160, 162 assembly from above. The hub disk 15 provides the luminaire (device) its rotational ability for horizontal rotational orientation, and can also, once aligned, fixate and secure the assembly in place.

The present figure shows a power or power and data conductor 118 coupled at one end to the luminaire device housing 162 and at the other end to a modular wiring system splitter 171. The power or power and data cables 130 are shown coupled to the support structure 2 by straps 169. The power/data extender cables 130 shown can include at least one conductor 132 that conveys power/data through the splitter to power consuming devices beyond.

Through the splitter 171 the power/data can be conveyed to conductors 118 that conveys power/data to a device coupled below and at least one additional power/data consuming device in the vicinity. In other embodiments where modular wiring systems are not used, power/data can be delivered to a luminaire by conventional pipe and wire assembly that can include a J box.

The present figure demonstrates one example of an “all in one” luminaire assembly construction method wherein the mechanical, electrical and luminaire alignments can be accomplished in one step. This method is contrary to more traditional construction practices that require at least two passes.

ELEMENT LIST

| | |
|---|---|
| 1. | Connector |
| 2. | Ceiling Support Structure |
| 3. | J box |
| 4. | J box Exterior Wall |
| 5. | Device Alignment Bore |
| 6. | J box Knockout Opening |
| 7. | J box Cover |
| 8. | J box Flange |
| 9. | Flange Bore |
| 10. | Hub |
| 11. | Collar |
| 12. | Elongated Bore |
| 13. | Protrusion |
| 14. | Protrusion Bore |
| 15. | Hub Disk |
| 16. | Fastener |
| 17. | Hub Mounting Bore |
| 18. | Eye Loop/Hook Fastener |
| 19. | Extender Arm |
| 20. | Cable and/or Chain |
| 21. | Conductor |
| 22. | Receptacle |
| 23. | Power Consuming Device |
| 24. | Circuitry Busway Hub |
| 25. | Switching Device |
| 26. | Central Through Opening |
| 28. | Safety Bore |
| 29. | Lock Bolt |
| 30. | Ceiling Suspended Device |
| 100. | Power Distribution Hub (PDH) |
| 102. | Drop Cord (DC) |
| 104. | DC Receptacle |
| 106. | Insulated Hub Core |
| 108. | Circuit Selector |
| 110. | Hub's Mechanical Key |
| 112. | Data Port |
| 114. | J box Cover plate Bore |
| 115. | Hub Fold |
| 116. | Cover Plate to PDH |
| 118. | DC Conductor |
| 120. | DC Coupler |
| 122. | DC Electrical Plug |
| 130. | Extender Cable (EC) |
| 132. | EC Conductor |
| 134. | EC Coupler |
| 136. | EC Electrical Plug |
| 138. | EC Receptacle |
| 140. | EC Plug Mechanical Key |
| 142. | EC Insulated Plug Core |
| 146. | EC Plug Terminal Contacts |
| 148. | Coupler Fastening Ring |
| 150. | Coupler Threaded Extension |
| 152. | J box Through Opening |
| 154. | J box Cover Through Opening |
| 156. | J box Cover to PDH Bore |
| 158. | PDH Threaded Bore |
| 160. | Luminaire |
| 162. | Luminaire's Device Housing |
| 164. | J box Threaded Bore |
| 165. | Hub Mounting Tab |
| 166. | Mounting Bore |
| 167. | Extender Base |
| 168. | Reflector/Refractor |
| 169. | Conductor Strap |
| 170. | Hub Central Opening |
| 171. | Conductor Splitter |
| 180. | Mounting Device Conveying Power |

1. A suspensible mechanical or an electromechanical system, comprising:
a mechanical or electromechanical device;
a support system coupled to the mechanical or electromechanical device that enables the mechanical or electromechanical device to rotate about a central vertical axis of a center of gravity of the mechanical or electromechanical device, the support system includes a first mounting point distally positioned from a second mounting point such that the central vertical axis of a center of gravity of the mechanical or electromechanical device is positioned therebetween;
a first flexible tensile support connected at one end thereof to an overhead structure and connected at an opposite end thereof to the first mounting point;
a second flexible tensile support connected at one end thereof to the overhead structure and connected at an opposite end thereof to the second mounting point, wherein
in a steady state position, the first flexible tensile support and the second flexible tensile support hold the mechanical or electromechanical device in a horizontal or substantially horizontal orientation, and
in response to the mechanical or electromechanical device being contacted by a moving object, the first flexible tensile support and the second flexible tensile support restore the mechanical or electromechanical device to the steady-state position.

2. The mechanical or electromechanical system of claim 1, further comprising a conductor that conveys power to the mechanical or electromechanical device from above.

3. The mechanical or electromechanical system of claim 1, wherein the mechanical or electromechanical device is the electromechanical device includes a light source configured to emit light in at least one of a symmetrical pattern or an asymmetrical pattern.

4. The mechanical or electromechanical system of claim 3, wherein the light source is aligned with at least one other light emitting device.

5. The mechanical or electromechanical system of claim 2, wherein the mechanical or electromechanical device includes a light source comprising orientation-specific lensed optics.

6. The mechanical or electromechanical system of claim 1, wherein the mechanical or electromechanical device is integrally coupled with the support system, and the second mounting point is coupled to the mechanical or electromechanical device, and the second flexible tensile support is fixedly secured to the second mounting point.

7. The mechanical or electromechanical system of claim 1, wherein the support system enables lateral rotation of the mechanical or electromechanical device.

8. A mechanical or an electromechanical suspended device, comprising:
a mechanical or electromechanical device having a center of gravity;
a support system coupled to the mechanical or electromechanical device that enables the mechanical or electromechanical device to rotate about a central vertical axis of a center of gravity of the mechanical or electromechanical device, the support system includes at least two distal mounting points relative to a housing of the mechanical or electromechanical device; and
at least two tensile supports coupling the at least two distal mounting points to an overhead structure to create a mechanical equilibrium plane, wherein
the at least two distal mounting points are positioned such that a central vertical axis of the center of gravity is located between the at least two distal mounting points, and
a displacement of the mechanical or electromechanical device from a set orientation increases a potential energy of the device such that gravity acts as a constant force to create a restorative gravitational torque that pulls the mechanical or electromechanical device back toward the set orientation.

9. The device of claim 8, wherein the mechanical or electromechanical device is a luminaire configured to house a light source with specialized lensed optics.

10. The device of claim 9, wherein the specialized lensed optics provide an asymmetrical light distribution that directs light in one direction at a specific angle.

11. The device of claim 10, wherein the support system comprises a hub configured to rotate horizontally and permanently lock via at least one fastener to ensure a predetermined light intensity distribution remains directed at an intended vertical or horizontal surface.

12. The device of claim 8, wherein the support system comprises an orientation hub including at least one elongated bore configured to receive a protrusion from the mechanical or electromechanical device to allow rotational alignment.

13. The device of claim 8, wherein the mechanical or electromechanical device is integrally coupled with the support system, and the second mounting point is coupled to the mechanical or electromechanical device, and the second flexible tensile support is fixedly secured to the second mounting point.

14. The device of claim 8, wherein the support system includes markings configured to provide an angular rotational displacement reading of the mechanical or electromechanical device relative to a base reference.

15. A method of suspending and orienting an orientation-specific mechanical or electromechanical device from a structure above, the method comprising:
coupling an orientation hub to a top surface of the mechanical or electromechanical device;
suspending the orientation hub from an overhead structure to a substantially horizontal orientation using at least two tensile supports mounted distally from one another to establish a restorative gravitational torque;
rotating the mechanical or electromechanical device about a central vertical axis to a settable alignment orientation;
securing the mechanical or electromechanical device to the orientation hub using at least one fastener once the settable alignment orientation is set; and
automatically restoring the orientation hub to the substantially horizontal position after the orientation-specific mechanical or electromechanical device is contacted by a moving object.

16. The method of claim 15, further comprising conveying power to the mechanical or electromechanical device via a conductor that extends through a central through-opening in the orientation hub.

17. The method of claim 15, wherein the rotating step is performed while the mechanical or electromechanical device is electrically powered.

18. The method of claim 15, further comprising setting the orientation of the mechanical or electromechanical device using reference markings on the orientation hub prior to lifting and mounting the device.

19. The method of claim 15, wherein the mechanical or electromechanical device is a luminaire with asymmetrical optics, the method further comprising rotating the luminaire horizontally to optimally illuminate a targeted vertical surface.

20. The method of claim 15, further comprising consolidating mechanical installation, electrical connection, and device alignment into a single pass construction process.
